(19) United States
(12) Patent Application Publication
(10) Pub. No.: US 2026/0134402 A1
(43) Pub. Date: May 14, 2026

(54) METHODS AND SYSTEMS FOR GENERATING AND IMPLEMENTING RECOMMENDATIONS FOR IMPROVING DESIGNS OF ELECTRONIC MAIL MESSAGES

(71) Applicant: Litmus Software, Inc., Cambridge, MA (US)

(72) Inventors: Matthew Brindley, Guilford, CT (US); Matthew Gore, Needham, MA (US); Brian Feucht, Wenatchee, WA (US)

(21) Appl. No.: 19/386,408

(22) Filed: Nov. 12, 2025

Related U.S. Application Data
(60) Provisional application No. 63/719,818, filed on Nov. 13, 2024.

(51) Int. Cl. G06Q 10/107; H04L 51/18; H04L 51/21

(52) U.S. Cl. CPC G06Q 10/107; H04L 51/18; H04L 51/21

(57) ABSTRACT

A method for generating and implementing recommendations for improving designs of electronic mail (email) messages includes rendering, by a capture engine executing on a first computing device, an unsent email message in an email client. The method includes transmitting, by the capture engine, to a recommendation engine, a representation of the rendered unsent email message. The method includes generating, by a large language model executed by the recommendation engine, a predicted level of reader engagement, a recommendation for improving the predicted level of reader engagement with the unsent email message, and computer code for implementing the recommendation. The method includes transmitting, by the first computing device, the generated computer code to an email service provider associated with the unsent email message.

### CROSS-REFERENCE TO RELATED APPLICATIONS

This application claims the benefit of U.S. patent application Ser. No. 63/719,818, filed on Nov. 13, 2024, entitled “Methods and Systems for Generating and Implementing Recommendations for Improving Designs of Electronic Mail Messages,” which is hereby incorporated by reference.

### BACKGROUND

The disclosure relates to improving electronic mail (email) messages. More particularly, the methods and systems described herein relate to functionality for monitoring email messages during or subsequent to drafting and for generating and implementing recommendations for improving designs of email messages.

Conventional systems allow users to generate email messages and to determine a level of recipient engagement with email messages by one or more recipients of the email messages after transmission of the generated email messages. However, conventional systems typically fail to provide recommendations for improving that level of recipient engagement before the messages are sent while the senders can still make modifications to improve the level of recipient engagement. Similarly, conventional systems typically fail to provide recommendations for improving levels of accessibility, or optimizing rendering for different email clients, or for increasing levels of recipient interaction with the email messages. Therefore, there is a need for methods and systems that make recommendations to improve designs of email messages before the transmission of such messages.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a block diagram depicting an embodiment of a system for improving designs of email messages;

FIG. 2 is a flow diagram depicting an embodiment of a method for improving designs of email messages;

FIG. 3 is a flow diagram depicting an embodiment of a method for improving designs of email messages; and

FIGS. 4A-4C are block diagrams depicting embodiments of computers useful in connection with the methods and systems described herein.

### DETAILED DESCRIPTION

The present disclosure relates to methods and systems for improving designs of electronic mail message templates.

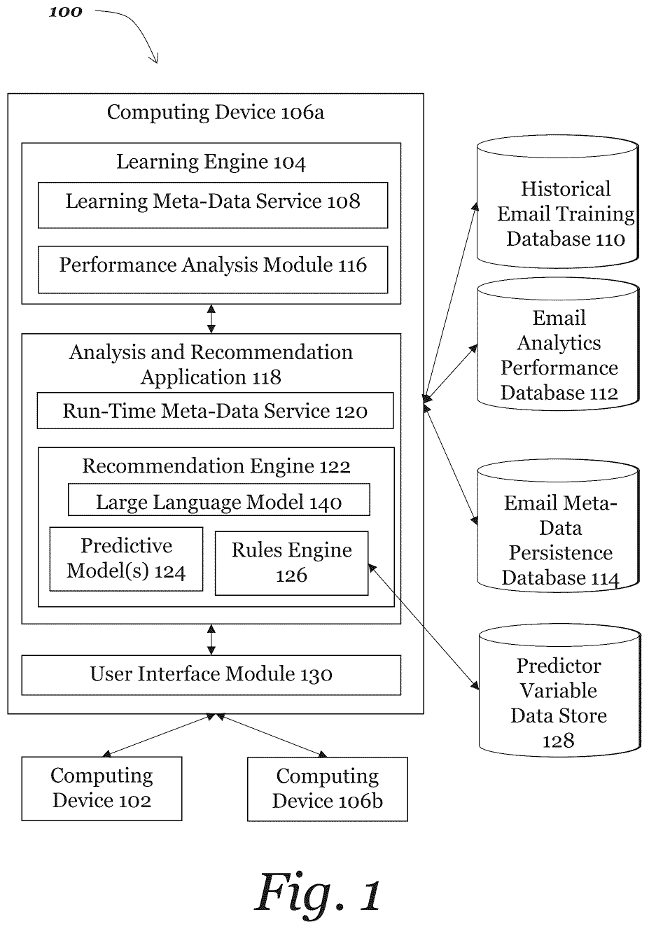

Referring now to FIG. 1, a block diagram depicts one embodiment of a system 100 for improving designs of email messages. The system 100 includes a first computing device 106a, a second computing device 102, a third computing device 106b, a learning engine 104, a learning meta-data service 108, a historical email training database 110, an email analytics performance database 112, an email meta-data persistence database 114, a performance analysis module 116, an analysis and recommendation application 118, a run-time meta-data service 120, a recommendation engine 122, at least one predictive model 124, a rules engine 126, a predictor variable data store 128, a user interface module 130, and a large language model 140.

An unsent (or “draft”) email message may be a hypertext markup language (HTML) document or a document written in another programming or markup language. The draft email message may be a document designed by a user of the system 100. The draft email message may include metadata, including information about content or design elements of the draft email message. Metadata including information about design elements of the draft email message may include information such as font color, font size, a number of images included in the draft email message, a number of links (e.g., HTML links to one or more web pages), and so on. Metadata including information about content elements of the draft email message may include information about average sentence length, a number of sentences in a paragraph, a number of paragraphs, a reading level associated with vocabulary used in the draft email message, a number of calls to action, one or more results from applying natural language processing to at least one word used in the text of the draft email message. This metadata may be analyzed to identify correlations between characteristics of the email messages (e.g., values of certain predictor variables) and a level of recipient engagement with the email messages. Recipient engagement may include actions such as clicking on embedded HTML links within the email messages, opening a message, a length of time spent engaging with the email messages (e.g., reading the email messages or looking at the email messages or having the email messages open within an email client application), printing the email messages, replying to or forwarding the email messages, or other interaction with a content or design element of the email messages.

Referring still to FIG. 1, the first computing device 106a may execute the learning engine 104. The first computing device 106a may execute the analysis and recommendation application 118. The first computing device 106a may execute the user interface module 130. In some embodiments, not shown in FIG. 1, the user interface module 130 may be executed by a third computing device 106c, with which the first computing device 106a is in communication.

In some embodiments, the learning engine 104 is a software module. In other embodiments, the learning engine 104 is a hardware module. The learning engine 104 may execute the learning meta-data service 108. The learning engine 104 may execute the performance analysis module 116.

In some embodiments, the learning meta-data service 108 is a software module. In other embodiments, the learning meta-data service 108 is a hardware module. The learning meta-data service 108 may have access to a plurality of sent email messages sent by a second computing device 102b (not shown) on a second network (not shown). The learning meta-data service 108 may have access to the plurality of sent email messages via a historical email training database 110 or other data source storing email messages sent on a separate network. By way of example, a first entity executing the system 100 may have a relationship with users of both the system 100 and of a service provided by a second entity allowing users to send email messages on a separate network and the relationship may allow for the first entity to access the email messages of the users sent via the service of the second entity. As another example, the first entity executing the system 100 may also provide functionality allowing users to send email messages and may have access to those sent email messages. Therefore, the first computing device 106a may be in communication with the second computing device 106b to retrieve one or more historical email data.

The learning meta-data service 108 may include functionality for parsing meta-data of a sent email message to identify a value within the metadata for one or more variables (e.g., variables that were identified in an enumeration of variables hard coded into the learning meta-data service 108). By way of example, and without limitation, the learning meta-data service 108 may determine that a variable in metadata is font color and that the value for the font color variable in a particular email message is red; the learning meta-data service 108 may store the variable value in association with an identification of that particular email message in the email meta-data persistence database 114. As mentioned above, there are many different types of meta-data; additional examples include, without limitation, a number of calls to action, whether or not the email message contains any images, and a natural language processing readability index for at least one portion of text included in the email message.

In some embodiments, the performance analysis module 116 is a software module. In other embodiments, the performance analysis module 116 is a hardware module. The performance analysis module 116 may include functionality for retrieving data from the email meta-data persistence database 114. The performance analysis module 116 may include functionality for retrieving data from the email analytics performance data 112. The performance analysis module 116 may make data retrieved from the email meta-data persistence database 114 and/or from the email analytics performance data 112 available for analysis. The performance analysis module 116 may include functionality for receiving one or more results of an analysis of meta-data of a sent email message for the purposes of determining how the email message performed with respect to a level of recipient engagement - for example, by using linear regression or resampling techniques, analyses may determine that an email message had a certain level of recipient engagement and, after comparison with other, similar sent email messages, analyses may determine a level of performance of the email message based on the level of recipient engagement and identify characteristics of the email message and its metadata that contributed to the level of performance. The performance analysis module 116 may receive this analysis for use in making recommendations for improving levels of performance in subsequent email messages. The performance analysis module 116 may receive an identification of validated predictor variables for email messages having a higher level of performance than a threshold level (the threshold level possibly specified by a user as part of administration of the system). The performance analysis module 116 may receive these analyses and validated predictor variables from a variety of sources. For example, and without limitation, an unsupervised machine learning component may generate the analyses and identify the validated predictor variables. As another example, and without limitation, a human may provide the analyses and the validated predictor variables. The performance analysis module 116 may store received data in a predictor variable data store 128 for use by one or more components of the recommendation engine 122.

The performance analysis module 116 may include functionality (such as an Application Programming Interface (API) or a user interface) executed to receive at least one predictive model 124. The performance analysis module 116 may include functionality to provide the recommendation engine 122 with access to the at least one predictive model 124. For example, the performance analysis module 116 may receive the at least one predictive model 124 from an unsupervised learning component (not shown). As another example, and without limitation, a user of the system 100 may provide the performance analysis module 116 with the at least one predictive model 124.

Therefore, the learning engine 104 may include functionality for accessing at least one previously sent email message from a plurality of historical email training data, identify within metadata of the previously sent email message a value of at least one variable, make that identified value available for analysis, and store one or more predictive models and one or more validated predictor variables that are indicative of levels of recipient engagement with the previously sent email messages; for example, without limitation, an indication that font color being red in email messages having a certain keyword in the content are more likely to engage readers or, as another example, email messages including a certain number of images and having at least one keyword in the content indicating the email message relates to a transaction or to marketing or to another topic are likely to have a higher level of recipient engagement than other emails.

In some embodiments, the analysis and recommendation application 118 is a software module. In other embodiments, the analysis and recommendation application 118 is a hardware module. The analysis and recommendation application 118 may execute the run-time meta-data service 120. The analysis and recommendation application 118 may execute the recommendation engine 122.

In some embodiments, the run-time meta-data service 120 is a software module. In other embodiments, the run-time meta-data service 120 is a hardware module. The run-time meta-data service 120 may provide the functionality of the learning meta-data service 108. The run-time meta-data service 120 may be in communication with the user interface module 130. The run-time meta-data service 120 may include functionality for retrieving metadata associated with an email message while the email message is being drafted.

In some embodiments, the user interface module 130 is a software module. In other embodiments, the user interface module 130 is a hardware module. The user interface module 130 may include functionality for generating and displaying a user interface to a user (e.g., a user of the computing device 102). Alternatively, the user interface module 130 may be in communication with a module that generates and displays a user interface to a user; in such an embodiment, the user interface module 130 may transmit a recommendation generated by the analysis and recommendation application 118 to the module that generates and displays the user interface with an instruction to modify a display of the user interface to include the generated recommendation. In some embodiments, the recommendation engine 122 provides the functionality of the user interface module 130; for example, the recommendation engine 122 may include a web service that a graphical user interface may call during an email drafting process. In other embodiments, the recommendation engine 122 is in communication with the user interface module 130, which is provided as a web service.

The recommendation engine 122 may execute the at least one predictive model 124 to analyze metadata of the draft email message. The recommendation engine 122 may execute the at least one rules engine 126 to identify and apply a rule to the draft email message. The recommendation engine 122 may use data retrieved from the predictor variable data store 128 to complete a rule and apply the completed rule to the draft email message.

In some embodiments, the at least one predictive model 124 is a software module. In other embodiments, the at least one predictive model 124 is a hardware module. The at least one predictive model 124 may include or have access to one or more rules that are available for application to draft email messages. By way of example, and without limitation, a multivariate logistic regression analysis is one example of using a model that uses multiple predictor variables to predict a single outcome. Predictor variables may include, without limitation, a length of an email, a number of calls to action, a number of links, whether or not there are images within the email. Predicted outcome may be provided as a binary output of applying the at least one predictive model 124; for example, the predicted outcome may indicate high engagement vs. low engagement. Predictive models may be provided as logical software functions that are run as binary code.

In some embodiments, the rules engine 126 is a software module. In other embodiments, the rules engine 126 is a hardware module. The rules engine 126 may include or have access to one or more rules that are available for application to draft email messages. As one example, and without limitation, a rule may specify that a subject line having a number of characters under a threshold number of characters performs better (e.g., exceeds a threshold level of recipient engagement) than a subject line having a number of characters that exceeds the threshold number of characters.

In some embodiments, the databases 110, 112, 114, and 128 in the system 100 (referred to generally hereafter as the databases) may be an ODBC-compliant database. For example, the databases may be provided as an ORACLE database, manufactured by Oracle Corporation of Redwood Shores, CA. In other embodiments, the databases can be a Microsoft ACCESS database or a Microsoft SQL server database, manufactured by Microsoft Corporation of Redmond, WA. In other embodiments, the databases can be a SQLite database distributed by Hwaci of Charlotte, NC, or a PostgreSQL database distributed by The PostgreSQL Global Development Group. In still other embodiments, the databases may be a custom-designed database based on an open source database, such as the MYSQL family of freely available database products distributed by MySQL AB Corporation of Uppsala, Sweden. In other embodiments, examples of databases include, without limitation, structured storage (e.g., NoSQL-type databases and BigTable databases), HBase databases distributed by The Apache Software Foundation of Forest Hill, MD, MongoDB databases distributed by 10Gen, Inc., of New York, NY, an AWS DynamoDB distributed by Amazon Web Services and Cassandra databases distributed by The Apache Software Foundation of Forest Hill, MD. In further embodiments, the databases may be any form or type of database.

Although, for ease of discussion, the learning engine 104, the learning meta-data service 108, the historical email training database 110, the email analytics performance database 112, the email meta-data persistence database 114, the performance analysis module 116, the analysis and recommendation application 118, the run-time meta-data service 120, the recommendation engine 122, the at least one predictive model 124, the rules engine 126, the predictor variable data store 128, and the user interface module 130 are described in FIG. 1 as separate modules, it should be understood that this does not restrict the architecture to a particular implementation. For instance, these components may be encompassed by a single circuit or software function or, alternatively, distributed across a plurality of computing devices. In some embodiments, some of the components depicted in FIG. 1 are optional.

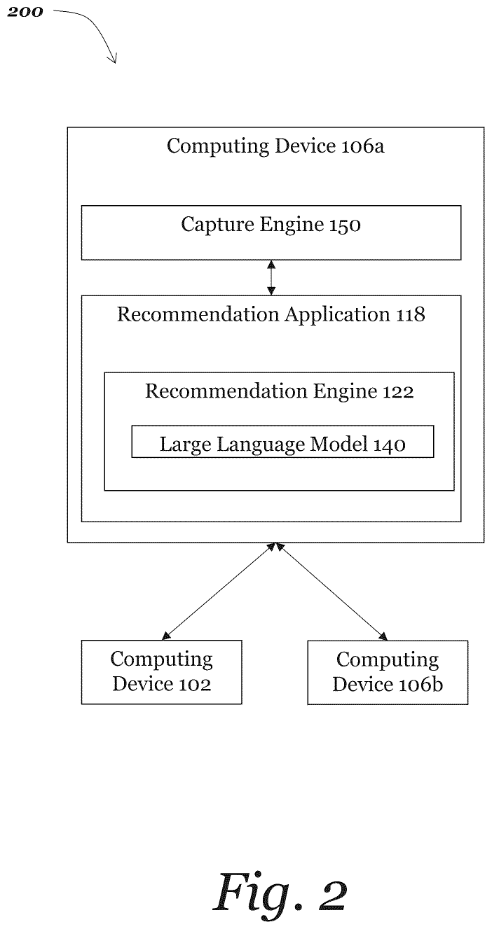

Referring now to FIG. 2, a system 200 includes a first computing device 106a, a second computing device 106b, a computing device 102, a recommendation application 118, a recommendation engine 122, a large language model 140, and a capture engine 150. The first computing device 106a, the second computing device 106b, the computing device 102, the recommendation application 118, and the recommendation engine 122, may be provided as described above in connection with FIG. 1.

In some embodiments, the capture engine 150 is a software program. In other embodiments, the capture engine 150 is a hardware module. The capture engine 150 may include functionality for executing scripts. The capture engine 150 may include functionality for generating and sending email messages. The capture engine 150 may include functionality for executing an email application, opening an email message (or draft email message) within the email application, and generating a screen shot of the opened email message (e.g., generating a digital image representing a rendering of the email message by the email application).

In some embodiments, the large language model 140 is a software module. In other embodiments, the large language model 140 is a hardware module. As will be understood by those of ordinary skill in the art, large-language models (LLMs) include very large deep neural networks trained to continue an input sequence of text. For instance, an LLM may be provided with an input sequence such as “I went to the store to” and generate the output sequence “buy some milk”. The task is induced by the prompt and the language model is trained on large data sets, including significant amounts of data irrelevant to the particular task. The recommendation engine 122 may implement the LLM 140 instead of the predictive model(s) 124 and the rules engine 126. The recommendation engine 122 may implement the LLM 140 in addition to the predictive model(s) 124 and the rules engine 126. The LLM 140 may be trained using some or all of the data in the databases 110, 112, 1134, and 128 described above in connection with FIG. 1.

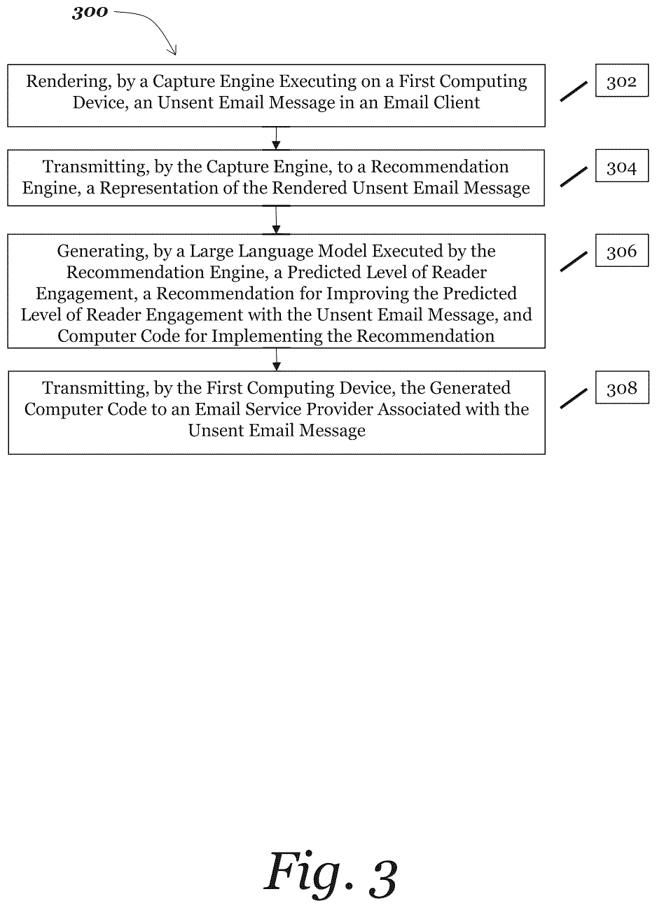

Referring now to FIG. 3, a method 300 for generating and implementing recommendations for improving designs of electronic mail (email) messages includes rendering, by a capture engine executing on a first computing device, an unsent email message in an email client (302). The method 300 includes transmitting, by the capture engine, to a recommendation engine, a representation of the rendered unsent email message (304). The method 300 includes generating, by a large language model executed by the recommendation engine, a predicted level of reader engagement, a recommendation for improving the predicted level of reader engagement with the unsent email message, and computer code for implementing the recommendation (306). The method 300 includes transmitting, by the first computing device, the generated computer code to an email service provider associated with the unsent email message (308).

Referring now to FIG. 3 in greater detail and in connection with FIGS. 1 and 2, a method 300 for generating and implementing recommendations for improving designs of electronic mail (email) messages includes rendering, by a capture engine executing on a first computing device, an unsent email message in an email client (302). The capture engine 150 may provide the functionality of the email client. The capture engine 150 may execute functionality for generating a display of a user interface into which a user may type the unsent email message. The capture engine 150 may be in communication with an email client that executes functionality for generating a display of a user interface into which the user may type the unsent email message.

The method 300 includes transmitting, by the capture engine, to a recommendation engine, a representation of the rendered unsent email message (304). The representation may be a screen shot. The representation may be a data structure including data representing elements of the unsent email message. The representation may include or be associated with metadata associated with the rendered unsent email message.

The method 300 includes generating, by a large language model executed by the recommendation engine, a predicted level of reader engagement, a recommendation for improving the predicted level of reader engagement with the unsent email message, and computer code for implementing the recommendation (306). Generating the recommendation may include generating a recommendation for improving a level of accessibility of at least image included in the unsent email message. By way of example, the LLM 140 may generate alternate text to associate with one or more images included in or with the unsent email message. Generating the recommendation may include generating a recommendation for improving a level of alignment with at least one attribute of a brand associated with the unsent email message. Generating the recommendation may include generating a recommendation for adding at least one user interface element to the unsent email message. User interface elements may include, without limitation, sentiment trackers, countdown timers, and other user interface elements. Generating the recommendation may include generating a recommendation to optimize a rendering of the unsent email message for a second email client. By way of example, the system may determine that a recipient of the unsent email message is associated with a target demographic and that members of the target demographic have a higher level of likelihood of using the second email client. Without limitation, and as just one example of a recommendation based on optimizing for the second email client, the system may determine that a user interface element in the second email client is not typically rendered as a round shape and the system may determine to modify the computer code associated with the unsent email so that any embedded elements that are to be rendered as round shapes will be replaced by or augmented with elements that can be rendered with a shape other than a round shape. Generating the recommendation may include generating a recommendation for modifying computer code associated with the unsent email to address a rendering issue identified in rendering the unsent email message in the email client.

The method 300 includes transmitting, by the first computing device, the generated computer code to an email service provider associated with the unsent email message (308). Transmitting the generated computer code may include transmitting, by the first computing device, the generated computer code to an email service provider associated with the unsent email message based upon receiving user input including an instruction to implement the recommendation.

Before transmitting the generated computer code to the email service provider, the method may include modifying a user interface generated by the first computing device to include a description of the recommendation and a user interface element for providing user input to instruct the first computing device to implement the recommendation. By way of example, the system may populate a dashboard displayed in a user interface also displaying a rendering of the unsent email and the dashboard may include elements such as a “ready to send” score, enumerations of recommendations for improving areas such as first impressions, accessibility, brand alignment, and compatibility with one or more email clients.

Before generating the recommendation and associated computer code, the method may include accessing, by the recommendation engine, via at least one computer network, a plurality of sent email messages sent by a second computing device associated with a user associated with the unsent email message and analyzing (i) each of the accessed plurality of sent email messages and (ii) metadata associated with each of the accessed plurality of sent email messages.

Therefore, the methods and systems described herein may provide functionality for analyzing unsent email and identifying one or more recommendations for improving attributes of the unsent email. Such attributes may include a general state of readiness of the unsent email for sending, including a level of confidence that the unsent email is ready for sending, how the unsent email will appear when sent to one or more email clients, how metadata such as a subject line of the unsent email will appear in an inbox when sent but not yet opened by a recipient, and how accessible the unsent email will be for the recipient (and, for example, how accessible the unsent email will be to a screen reader or other accessibility device available at a computing device of the recipient).

Before generating, the method may include determining at least one characteristic associated with each of the plurality of sent email message, the at least one characteristic associated with a level of reader engagement.

In some embodiments, therefore the methods described above are used instead of or in addition to a method for improving a predicted level of engagement with email messages that includes accessing, by a first module executed by a first computing device, via a first computer network, a plurality of sent email messages sent by a second computing device via a second computer network. The method may include analyzing, by the first module, metadata associated with each of the plurality of sent email messages. The method may include determining, by the first module, at least one characteristic of each of the plurality of sent email messages, based on the analysis of the metadata. The method may include storing, by the first module, in a database, performance analysis data generated for each of the plurality of sent email messages, based upon the analysis. The method may include accessing, by a second module executed by the first computing device, (i) a draft email message and (ii) metadata associated with the draft email message. The method may include determining, by the second module, that the first plurality of sent email messages has a threshold level of characteristics in common with the draft email message. The method may include selecting, by the second module, at least one predictive model to be applied to the draft email message, based on the determination of the threshold level of common characteristics between the plurality of sent email messages and the draft email message. The method may include applying, by a recommendation engine executed by the first computing device, the selected at least one predictive model to the metadata associated with the draft email message. The method may include applying, by the recommendation engine, to the metadata associated with the draft email message, at least one rule from a rules engine. The method may include generating, by the recommendation engine, at least one recommended action for improving a level of recipient engagement with an email sent based upon the draft email message, based upon the application of the at least one predictive model and of the at least one rule.

Such a method may include accessing, by a first module executed by a first computing device, via a first computer network, a plurality of sent email messages sent by a second computing device via a second computer network. The learning engine 104 may access the plurality of sent email messages, analyze the metadata associated with each of the plurality of sent email messages, determine at least one characteristic of each of the plurality of sent email messages based upon the analysis, and store performance analysis data generated for each of the plurality of sent email messages. The learning meta-data service 108 may receive the plurality of sent email messages. The plurality of sent email messages may be referred to as historical training data. The plurality of sent email messages may have been sent by a single user of the system. The plurality of sent email messages may have been sent by a plurality of users of the system (e.g., multiple users across one or more corporate accounts, optionally having been de-identified and aggregated); in his way, data from all users across one or more customers may be used to help improve a particular customer's campaigns so that data elements and recommendations learned across customers can help generate recommendations for a particular customer's current campaign. The learning meta-data service 108 may receive one or more .eml files and associated source HTML files. The learning meta-data service 108 may request the historical training data from the historical email training database 110. The learning meta-data service 108 may receive the historical training data responsive to an API call to a partner platform (e.g., to receive email messages sent by users of other systems instead of the system 100).

The method may include analyzing, by the first module, metadata associated with each of the plurality of sent email messages. The first module may be the learning engine 104. The first module may be a subcomponent of the learning engine 104. The first module may be the learning meta-data service 108 and the learning meta-data service 108 may analyze the metadata associated with each of the plurality of sent email messages. The learning meta-data service 108 may analyze the metadata associated with each of the plurality of sent email messages to identify within the metadata at least one variable describing at least one characteristic of each email in the plurality of sent email messages. The learning meta-data service 108 may parse at least a portion of a .eml file to identify one or more variables within the metadata. The learning meta-data service 108 may have access to an enumeration of variables to identify within the metadata of each of the plurality of sent email messages; for example, the learning meta-data service 108 may have such an enumeration hard coded into it during configuration or the learning meta-data service 108 may have access to an enumeration of variables stored in a database or other repository. The learning meta-data service 108 may search an email message (e.g., a .eml file and related source HTML) to determine whether at least one variable is included in the email message.

The method includes determining, by the first module, at least one characteristic of each of the plurality of sent email messages, based on the analysis of the metadata. The first module may be the learning engine 104. The first module may be a subcomponent of the learning engine 104. The first module may be the learning meta-data service 108 and the learning meta-data service 108 may determine at least one characteristic of each of the plurality of sent email messages, based on the analysis of the metadata. The learning meta-data service 108 may determine a value of a variable identified within the analyzed metadata to determine the at least one characteristic for each of the plurality of sent email messages. By way of example and without limitation, a variable may be font color and the learning meta-data service 108 may search a .eml file and related source HTML to determine whether the sent email message specified a font color, determine that the sent email message did specify a font color, identify what font color the sent email message specified, and determine that a characteristic of the sent email message is that it has a red font. As another example and without limitation, a variable may be whether a certain word or phrase is included in the sent email message; in such an example, the learning meta-data service 108 may execute a natural language processing component, provide the sent email message as input to the natural language processing component, and determine based on the output from the natural language processing component whether the word or phrase is included. As a further example and without limitation a variable may be whether a sent email message has a number of other variables set to values that suggest that the message should be categorized as having a particular profile—for example, that the sent email message is a transactional message or a marketing message or a message targeting a particular demographic—and the learning meta-data service 108 may execute one or more machine learning components (e.g., natural language processing engines, semantic meaning engines, and/or emotion analysis engines) to determine whether the sent email message should be characterized as having that particular profile.

The learning meta-data service 108 may modify a data store to include at least a portion of the analyzed metadata of each of the plurality of sent email messages; for example, modifying the email meta-data persistence database 114. The learning meta-data service 108 may store the results of the analysis of the metadata for subsequent use by the performance analysis module 116, by the run-time meta-data service 120, and/or by the recommendation engine 122. The learning meta-data service 108 may store the determined characteristic (e.g., a value identified for a particular value in a particular sent email message) for subsequent use by the performance analysis module 116, by the run-time meta-data service 120, and/or by the recommendation engine 122. The learning meta-data service 108 may store some or all of the metadata for a particular sent email message; for example, the learning meta-data service 108 may store at least a portion of the metadata for a particular sent email message in the email meta-data persistence database 114. The system 100 may store the historical training data in the email analytics performance database 112.

The method may include storing, by the first module, in a database, performance analysis data generated for each of the plurality of sent email messages, based upon the analysis. The first module may be the learning engine 104. The first module may be a subcomponent of the learning engine 104. The first module may be the performance analysis module 116. As described above in connection with FIG. 1, the performance analysis module 116 may receive validated predictor variables that indicate a level of recipient engagement that exceeds a threshold level of recipient engagement (which may be referred to, therefore, as a “well-performing email”). Such variables may have been identified and validated by a machine learning component executed by the learning engine 104 as part of an unsupervised learning model; alternatively, or in addition to such unsupervised learning, a user of the system 100 may have provided the identified and validated predictor variables after applying techniques such as linear regression and resampling to the values of the variables in the metadata identified by the learning meta-data service 108.

In some embodiments, the method may be considered to have a learning phase and a subsequent run-time execution phase. In the learning phase, the system 100 executes to identify the values for those variables that are indicative of a level of recipient engagement that exceeds a threshold, based on analyses of previously sent (and therefore “historical”) email messages. The historical training data may be selected based on instructions to analyze a plurality of types of email messages (e.g., transactions, marketing, training, etc.) for variables that are indicative of a level of recipient engagement that exceeds a threshold. The historical training data may be selected based on instructions to analyze one or more types of email messages sent by a particular user of the system (e.g., a company or other account using the system 100). The historical training data may be selected based on instructions to analyze one or more types of email messages within a particular industry (e.g., financial services or healthcare or other verticals) for variables that are indicative of a level of recipient engagement that exceeds a threshold. In the subsequent run-time execution phase, the system 100 executes to analyze an email message in the process of being drafted and to make recommendations to the drafter of the email message regarding modifications to the design or content of the draft email message that may improve a predicted level of recipient engagement. By way of example, and without limitation, the system 100 may execute functionality that determines that for draft emails relating to training messages within a healthcare vertical, fewer pictures lead to a recipient spending more time reading the email or, as another example, that, within a financial services vertical, more pictures lead to a higher likelihood that a reader will click on a link to a web site. These types of recommendations may assist a sender of an email in drafting an email message that will have a higher likelihood of engaging a reader of the email message at a level that exceeds a threshold level as pre-defined by the system 100.

The method, therefore, includes accessing, by a second module executed by the first computing device, (i) a draft email message and (ii) metadata associated with the draft email message. The second module may be the analysis and recommendation application 118. The second module may be a subcomponent of the analysis and recommendation application 118, such as the run-time meta-data service 120. The run-time meta-data service 120 may be a version of the learning meta-data service 108 that receives as input a draft email message instead of a previously-transmitted email message.

For example, and without limitation, the run-time meta-data service 120 may include functionality for receiving the draft email message metadata from the user interface module 130 while a user of the system 100 is accessing the user interface module 130. As another example, and without limitation the run-time meta-data service 120 may include functionality for receiving the draft email message metadata from the user interface module 130 after a user of the system 100 has provided user input indicating that the email message is in a drafting stage (e.g., saved but not yet sent or scheduled for transmission to recipients). As a further example, and without limitation, the run-time meta-data service 120 may include functionality for receiving the draft email message metadata from the user interface module 130 when a user of the system 100 has requested evaluation of the draft email message. To make such indications, the user of the system 100 may provide user input via a user interface received from the user interface module 130 by a computing device 102 of the user of the system 100.

The run-time meta-data service 120 may provide the functionality of the learning meta-data service 108. Therefore, upon accessing the draft email message and associated metadata, the run-time meta-data service 120 may analyze the metadata as described in connection with (204) above. Similarly, upon accessing the draft email message and associated metadata, the run-time meta-data service 120 may determine at least one characteristic of the draft email message, based upon the analysis of the metadata, as described in connection (206) above.

The method may include determining, by the second module, that the plurality of sent email messages has a threshold level of characteristics in common with the draft email message. The second module may be the analysis and recommendation application 118. The second module may be a subcomponent of the analysis and recommendation application 118, such as the run-time meta-data service 120. The threshold level may be defined during a configuration process upon initialization of the system 100. The threshold level may be pre-defined and configured into the run-time meta-data service 120 (e.g., hard-wired). The run-time meta-data service 120 may identify a value of each of a plurality of variables to determine at least one characteristic of the draft email message and use the determined at least one characteristic to determine whether the draft email message satisfies (or exceeds) the threshold level of characteristics. The run-time meta-data service 120 may execute a machine learning engine (e.g., a natural language processing engine) to determine a profile of the draft email message based upon one or more words within the draft email message and compare the determined profile to a stored profile of the plurality of sent email messages to determine whether the plurality of sent email messages has a threshold level of characteristics in common with the draft email message. The run-time meta-data service 120 may compare the draft email to the entirety of the plurality of sent email messages. Alternatively, the run-time meta-data service 120 may compare the draft email to a subset of the plurality of sent email messages; for example, the run-time meta-data service 120 may receive an instruction (e.g., via user input from a user of the system 100) to identify a subset of the plurality of sent email messages that are similar to the draft email (such as by topic, content similarities, customer, industry, or other filtering characteristic).

The method may include selecting, by the second module, at least one predictive model to be applied to the draft email message, based on the determination of the threshold level of common characteristics between the plurality of sent email messages and the draft email message. The second module may be the analysis and recommendation application 118. The second module may be a subcomponent of the analysis and recommendation application 118, such as the run-time meta-data service 120. The run-time meta-data service 120 may select at least one predictive model 124 associated with the plurality of sent email messages to apply to the draft email message. There may be a plurality of predictive models 124 associated with the plurality of sent email messages and the run-time meta-data service 120 may determine to select each of the plurality of predictive models 124 for application to the draft email message. The run-time meta-data service 120 may select a subset of a plurality of predictive models 124 associated with the plurality of sent email messages to be applied to the draft email message.

In some embodiments, each of a plurality of available predictive models 124 are to be applied to the draft email message, regardless of the level of commonality between the historical training emails and the draft email message; in such embodiments, the run-time meta-data service 120 may therefore provide to the recommendation engine an instruction to apply all available predictive models 124 to the draft email message and the associated metadata.

In other embodiments, the run-time meta-data service 120 selects the at least one predictive model to be applied, based on the determination of the threshold level of common characteristics between the plurality of sent email messages and the draft email message and on the determination of the type of the characteristic the plurality of sent email messages has in common with the draft email message.

In still other embodiments, the run-time meta-data service 120 identifies a subset of the plurality of sent email messages having a threshold level of characteristics in common with the draft email message and selects at least one predictive model 124 associated with the subset of the plurality of sent email message to be applied to the draft email message.

The method may include applying, by a recommendation engine executed by the first computing device, the selected at least one predictive model to the metadata associated with the draft email message. The run-time meta-data service 120 may transmit, to the recommendation engine 122, an identification of the selected at least one predictive model 124 to be applied to the draft email and the associated metadata of the draft email. The at least one predictive model 124 may have been generated by the performance analysis module 116. The at least one predictive model 124 may have been received by the performance analysis module 116. The recommendation engine 122 may apply as input to the at least one predictive model 124 the metadata values from the draft email message metadata, as identified by the run-time meta-data service 120. The at least one predictive model 124 generates predictive output. The predictive output may include an identification of a strength of the draft email message; that is, an identification of a characteristic which is associated with a level of recipient engagement that satisfies or exceeds a threshold level of recipient engagement. The predictive output may include an identification of a weakness of the draft email message; that is, an identification of a characteristic which is associated with a level of recipient engagement that fails to meet a threshold level of recipient engagement. The predictive output may include an identification of a plurality of strengths and weaknesses of the draft email message.

The method may include applying, by the recommendation engine, to the metadata associated with the draft email message, at least one rule from a rules engine. The run-time meta-data service 120 may have identified a rule to apply given one or more variable values within the metadata of the draft email message. The recommendation engine 122 may identify a rule within the rules engine 126 that is associated with a characteristic of the metadata or a variable within the metadata. The recommendation engine 122 may identify a variable within the predictor variable data store 128 for use with the identified rule within the rule engine 126; by way of example, a rule may specify that the recommendation engine 122 should check whether the draft email message meets a threshold length (e.g., number of words or sentences or paragraphs or other measure of length) and the predictive variable data store may specify what the threshold is. The recommendation engine 122 may determine to apply each of a plurality of rules within the rules engine 126 to the metadata. Alternatively, the rules engine 126 may identify a rule within the rules engine 126 that is associated with a characteristic of the metadata or a variable within the metadata and identify a variable within the predictor variable data store 128 for use with the identified rule.

By way of example and without limitation, in some embodiments, the recommendation engine 122 may apply at least one rule from the rules engine 126 to the draft email message (e.g., to the draft HTML) and determine whether the draft email message violates the rule. As another example, and without limitation, in some embodiments, the rules engine 126 may apply at least one rule to the draft email message (e.g., to the draft HTML) and determine whether the draft email message violates the rule. As a further example, some rules may be applicable to certain classes of email; for instance, the run-time meta-data service 120 may determine that an email is a in class of email referred to as marketing email (as opposed to, for example, being in a class of email referred to as transactional email) and that classification may ensure that only marketing email rules are applied.

The recommendation engine 122 may apply one or more rules to the predictive output generated by applying the at least one predictive model 124 to the metadata of the draft email message. In this way, the recommendation engine 122 may refine the predictive output. By way of example, some predictive models produce an output of a number on a scale (e.g., an email might score 60 out of 100 on its prediction of high engagement) and the rules engine 126 may allow thresholds to be set that would indicate that it would only make recommendation on emails with scores of 50 or below.

The rule engine output may include an identification of a strength of the draft email message; that is, an identification of a characteristic which is associated with a level of recipient engagement that satisfies or exceeds a threshold level of recipient engagement. The rule engine output may include an identification of a weakness of the draft email message; that is, an identification of a characteristic which is associated with a level of recipient engagement that fails to meet a threshold level of recipient engagement. The rule engine output may include an identification of a plurality of strengths and weaknesses of the draft email message.

The method may include generating, by the recommendation engine, at least one recommended action for improving a level of recipient engagement with an email sent based upon the draft email message, based upon the application of the at least one predictive model and of the at least one rule. The recommendation engine 122 may generate the at least one recommended action. For example, the recommendation engine 122 may generate the at least one recommended action by identifying a weakness in the output generated by the at least one predictive model 124, access a data structure mapping that weakness to a recommendation, and generate a recommendation for a user of the system 100 to address the weakness. Examples of generated recommendations include improving an engagement level by x % by reducing email length to below n characters or by including a certain number of images or by reducing a number of calls to action to above or below a threshold number. Other examples of recommended actions include recommendations regarding design, text, device optimization, send time recommendations, user interface features, program level recommendations (e.g., across a campaign of messages in which the draft email message is one of a plurality of email messages), and actions relating to engagement tracking and scroll depth.

The method may include displaying the generated recommendation within a user interface for drafting the draft email message. For example, the recommendation engine 122 may determine that a certain type of recommendation should be generated, access a database that has a mapping between the type of recommendation to be generated and text and images for use in generating the type of recommendation, and then generate the recommendation and provide the generated recommendation to the user interface module 130, which may then modify a user interface for drafting the draft email message to include the generated recommendation.

In some embodiments, the generated recommendation relates to a recommendation for an action to take before sending the draft email message that is not necessarily a direct modification to the draft email message itself. For example, the system may generate a recommendation identifying an email client application that the drafter of the email message should have tested for recipient engagement or other metric of performance, such as, without limitation, display of one or more design elements as the drafter intends the elements to display (e.g., the system 100 may generate a recommendation that the drafter of the email message consider how the message will appear when rendered by an email client application that is used by a certain percentage of the recipients of the draft email, as determined by analyzing previous message from the drafter of the email message to those recipients). In such embodiments, the recommendation is a recommendation to add a step to a workflow used in drafting and sending the email.

In some embodiments, the components described herein may execute one or more steps in the methods described above automatically, that is, without human intervention. In one of these embodiments, the system 100 executes completely automatically. In another of these embodiments, the performance analysis module 116 of the system 100 receives performance analysis data from a human and the system 100 performs the other steps automatically.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure, possibly in combination with other embodiments of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PYTHON, PROLOG, PERL, C, C++, C #, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

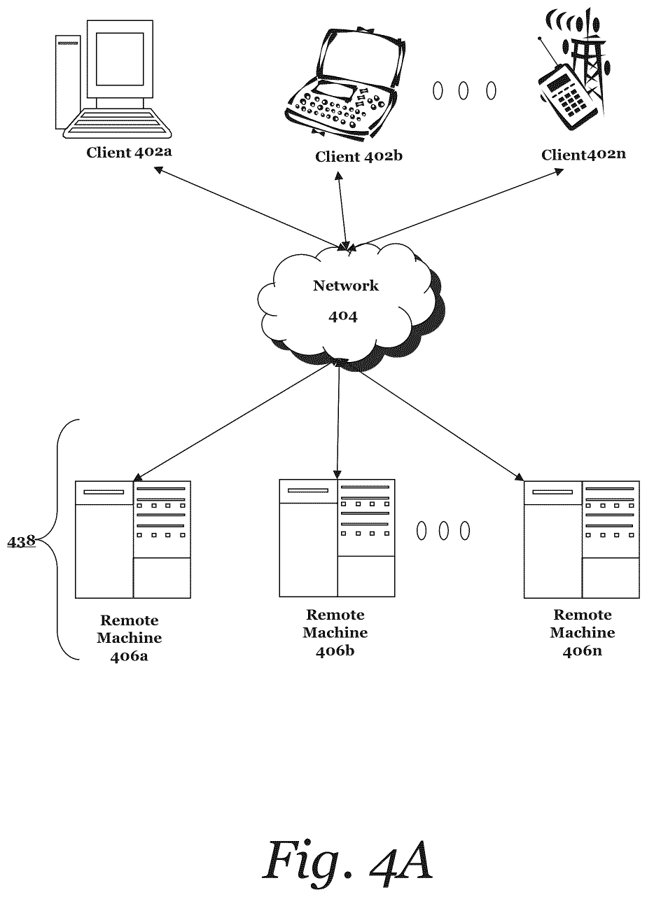

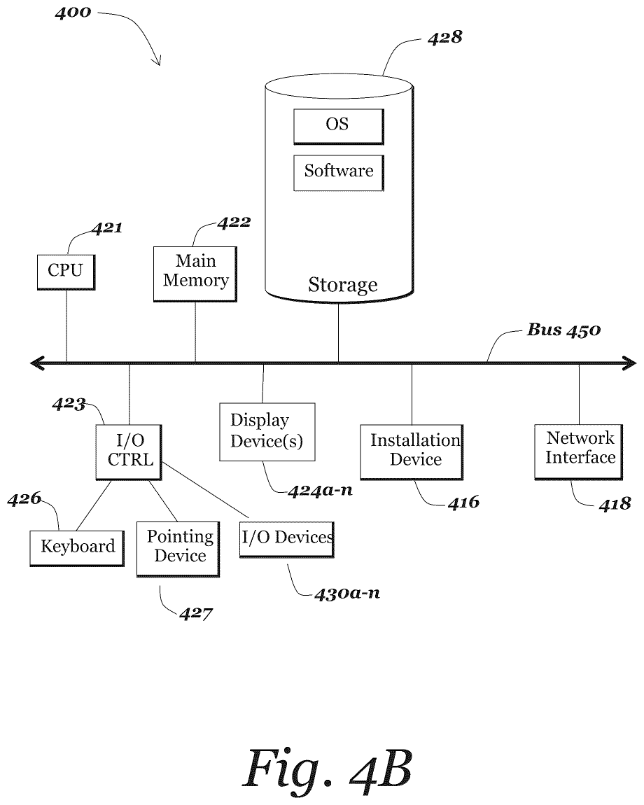

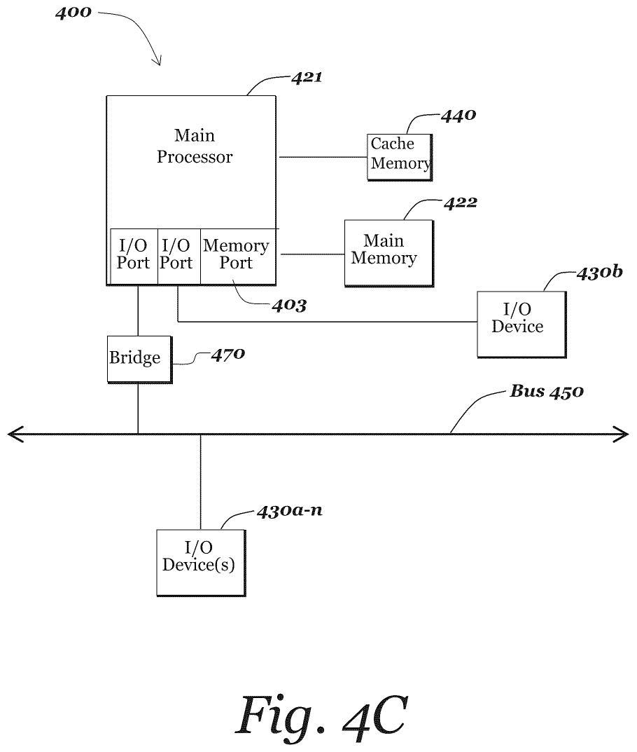

Referring now to FIGS. 4A, 4B, and 4C, block diagrams depict additional detail regarding computing devices that may be modified to execution functionality for implementing the methods and systems described above.

Referring now to FIG. 4A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 404.

Although FIG. 4A shows a network 404 between the client(s) 102 and the remote machines 106, the client(s) 102 and the remote machines 106 may be on the same network 404. The network 404 can be a local area network (LAN), such as a company Intranet, a metropolitan area network (MAN), or a wide area network (WAN), such as the Internet or the World Wide Web. In some embodiments, there are multiple networks 404 between the client(s) and the remote machines 106. In one of these embodiments, a network 404′ (not shown) may be a private network and a network 404 may be a public network. In another of these embodiments, a network 404 may be a private network and a network 404′ a public network. In still another embodiment, networks 404 and 404′ may both be private networks. In yet another embodiment, networks 404 and 404′ may both be public networks.

The network 404 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 404 may comprise a wireless link, such as an infrared channel or satellite band. The topology of the network 404 may be a bus, star, or ring network topology. The network 404 may be of any such network topology as known to those ordinarily skilled in the art capable of supporting the operations described herein. The network 404 may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client(s) 102 and a remote machine 106 (referred to generally as computing devices 100) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client(s) 102 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client(s) 102.

In one embodiment, a computing device 106 provides functionality of a web server. In some embodiments, a web server 106 comprises an open-source web server, such as the NGINX web servers provided by NGINX, Inc., of San Francisco, CA, or the APACHE servers maintained by the Apache Software Foundation of Delaware. In other embodiments, the web server executes proprietary software, such as the INTERNET INFORMATION SERVICES products provided by Microsoft Corporation of Redmond, WA, the ORACLE IPLANET web server products provided by Oracle Corporation of Redwood Shores, CA, or the BEA WEBLOGIC products provided by BEA Systems of Santa Clara, CA.

In some embodiments, the system may include multiple, logically-grouped remote machines 106. In one of these embodiments, the logical group of remote machines may be referred to as a server farm 438. In another of these embodiments, the server farm 438 may be administered as a single entity.

FIGS. 4B and 4C depict block diagrams of a computing device 400 useful for practicing an embodiment of the client(s) 102 or a remote machine 106. As shown in FIGS. 4B and 4C, each computing device 400 includes a central processing unit 421, and a main memory unit 422. As shown in FIG. 4B, a computing device 400 may include a storage device 428, an installation device 416, a network interface 418, an I/O controller 423, display devices 424a-n, a keyboard 426, a pointing device 427, such as a mouse, and one or more other I/O devices 430a-n. The storage device 428 may include, without limitation, an operating system and software. As shown in FIG. 4C, each computing device 400 may also include additional optional elements, such as a memory port 403, a bridge 470, one or more input/output devices 430a-n (generally referred to using reference numeral 430), and a cache memory 440 in communication with the central processing unit 421.

The central processing unit 421 is any logic circuitry that responds to and processes instructions fetched from the main memory unit 422. In many embodiments, the central processing unit 421 is provided by a microprocessor unit, such as: those manufactured by Intel Corporation of Mountain View, CA; those manufactured by Motorola Corporation of Schaumburg, IL; those manufactured by Transmeta Corporation of Santa Clara, CA; those manufactured by International Business Machines of White Plains, NY; or those manufactured by Advanced Micro Devices of Sunnyvale, CA. Other examples include SPARC processors, ARM processors, processors used to build UNIX/LINUX “white” boxes, and processors for mobile devices. The computing device 400 may be based on any of these processors, or any other processor capable of operating as described herein.

Main memory unit 422 may be one or more memory chips capable of storing data and allowing any storage location to be directly accessed by the microprocessor 421. The main memory 422 may be based on any available memory chips capable of operating as described herein. In the embodiment shown in FIG. 4B, the processor 421 communicates with main memory 422 via a system bus 450. FIG. 4C depicts an embodiment of a computing device 400 in which the processor communicates directly with main memory 422 via a memory port 403. FIG. 4C also depicts an embodiment in which the main processor 321 communicates directly with cache memory 440 via a secondary bus, sometimes referred to as a backside bus. In other embodiments, the main processor 421 communicates with cache memory 440 using the system bus 450.

In the embodiment shown in FIG. 4B, the processor 421 communicates with various I/O devices 430 via a local system bus 450. Various buses may be used to connect the central processing unit 421 to any of the I/O devices 430, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 424, the processor 421 may use an Advanced Graphics Port (AGP) to communicate with the display 424. FIG. 4C depicts an embodiment of a computer 400 in which the main processor 421 also communicates directly with an I/O device 430b via, for example, HYPERTRANSPORT, RAPIDIO, or INFINIBAND communications technology.

One or more of a wide variety of I/O devices 430a-n may be present in or connected to the computing device 400, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 423 as shown in FIG. 4B. Furthermore, an I/O device may also provide storage and/or an installation medium 416 for the computing device 400. In some embodiments, the computing device 400 may provide USB connections (not shown) to receive handheld USB storage devices such as the USB Flash Drive line of devices manufactured by Twintech Industry, Inc. of Los Alamitos, CA.

Referring still to FIG. 4B, the computing device 400 may support any suitable installation device 416, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 400 may provide functionality for installing software over a network 404. The computing device 400 may further comprise a storage device, such as one or more hard disk drives or redundant arrays of independent disks, for storing an operating system and other software. Alternatively, the computing device 400 may rely on memory chips for storage instead of hard disks.

Furthermore, the computing device 400 may include a network interface 418 to interface to the network 404 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 400 communicates with other computing devices 100′ via any type and/or form of gateway or tunneling protocol such as Secure Socket Layer (SSL) or Transport Layer Security (TLS). The network interface 418 may comprise a built-in network adapter, network interface card, PCMCIA network card, card bus network adapter, wireless network adapter, USB network adapter, modem, or any other device suitable for interfacing the computing device 400 to any type of network capable of communication and performing the operations described herein.

In further embodiments, an I/O device 430 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 400 of the sort depicted in FIGS. 4B and 4C typically operates under the control of operating systems, which control scheduling of tasks and access to system resources. The computing device 400 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95,WINDOWS 98, WINDOWS 2000, WINDOWS NT 3.1-4.0, WINDOWS CE, WINDOWS XP, WINDOWS 7, WINDOWS 8, WINDOWS VISTA, and WINDOWS 10, all of which are manufactured by Microsoft Corporation of Redmond, WA; any version of MAC OS manufactured by Apple Inc. of Cupertino, CA; OS/2 manufactured by International Business Machines of Armonk, NY; Red Hat Enterprise Linux, a Linus-variant operating system distributed by Red Hat, Inc., of Raleigh, NC; Ubuntu, a freely-available operating system distributed by Canonical Ltd. of London, England; or any type and/or form of a Unix operating system, among others.

The computing device 400 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 400 may have different processors, operating systems, and input devices consistent with the device. In other embodiments, the computing device 400 is a mobile device, such as a JAVA-enabled cellular telephone/smartphone or personal digital assistant (PDA). The computing device 400 may be a mobile device such as those manufactured, by way of example and without limitation, by Apple Inc. of Cupertino, CA; Google/Motorola Div. of Ft. Worth, TX; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, CA; Sony Ericsson Mobile Communications AB of Lund, Sweden; or Research In Motion Limited of Waterloo, Ontario, Canada. In yet other embodiments, the computing device 400 is a smartphone, POCKET PC, POCKET PC PHONE, or other portable mobile device supporting Microsoft Windows Mobile Software.

In some embodiments, the computing device 400 is a digital audio player. In one of these embodiments, the computing device 400 is a digital audio player such as the Apple IPOD, IPOD TOUCH, IPOD NANO, and IPOD SHUFFLE lines of devices manufactured by Apple Inc. In another of these embodiments, the digital audio player may function as both a portable media player and as a mass storage device. In other embodiments, the computing device 400 is a digital audio player such as those manufactured by, for example, and without limitation, Samsung Electronics America of Ridgefield Park, NJ, or Creative Technologies Ltd. of Singapore. In yet other embodiments, the computing device 400 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 400 comprises a combination of devices, such as a mobile phone combined with a digital audio player or portable media player. In one of these embodiments, the computing device 400 is a device in the Google/Motorola line of combination digital audio players and mobile phones. In another of these embodiments, the computing device 400 is a device in the IPHONE smartphone line of devices manufactured by Apple Inc. In still another of these embodiments, the computing device 400 is a device executing the ANDROID open source mobile phone platform distributed by the Open Handset Alliance; for example, the device 400 may be a device such as those provided by Samsung Electronics of Seoul, Korea, or HTC Headquarters of Taiwan, R.O.C. In other embodiments, the computing device 400 is a tablet device such as, for example and without limitation, the IPAD line of devices manufactured by Apple Inc. ; the PLAYBOOK manufactured by Research In Motion; the CRUZ line of devices manufactured by Velocity Micro, Inc. of Richmond, VA; the FOLIO and THRIVE line of devices manufactured by Toshiba America Information Systems, Inc. of Irvine, CA; the GALAXY line of devices manufactured by Samsung; the HP SLATE line of devices manufactured by Hewlett-Packard; and the STREAK line of devices manufactured by Dell, Inc. of Round Rock, TX.

Having described certain embodiments of methods and systems for improving a predicted level of engagement with email messages, it will now become apparent to one of skill in the art that other embodiments incorporating the concepts of the disclosure may be used.

What is claimed is:

1. A method for generating and implementing recommendations for improving designs of electronic mail (email) messages, the method comprising:
rendering, by a capture engine executing on a first computing device, an unsent email message in an email client;
transmitting, by the capture engine, to a recommendation engine, a representation of the rendered unsent email message;
generating, by a large language model executed by the recommendation engine, a predicted level of reader engagement, a recommendation for improving the predicted level of reader engagement with the unsent email message, and computer code for implementing the recommendation; and
transmitting, by the first computing device, the generated computer code to an email service provider associated with the unsent email message.

2. The method of claim 1, wherein generating further comprises generating a recommendation for improving a level of accessibility of at least image included in the unsent email message.

3. The method of claim 1, wherein generating further comprises generating a recommendation for improving a level of alignment with at least one attribute of a brand associated with the unsent email message.

4. The method of claim 1, wherein generating further comprises generating a recommendation for adding at least one user interface element to the unsent email message.

5. The method of claim 1, wherein generating further comprises generating a recommendation to optimize a rendering of the unsent email message for a second email client.

6. The method of claim 1, wherein generating further comprises generating a recommendation for modifying computer code associated with the unsent email to address a rendering issue identified in rendering the unsent email message in the email client.

7. The method of claim 1 wherein transmitting the generated computer code further comprises transmitting, by the first computing device, the generated computer code to an email service provider associated with the unsent email message based upon receiving user input including an instruction to implement the recommendation.

8. The method of claim 1 further comprising, before transmitting the generated computer code to the email service provider, modifying a user interface generated by the first computing device to include a description of the recommendation and a user interface element for providing user input to instruct the first computing device to implement the recommendation.

9. The method of claim 1 further comprising, before generating, accessing, by the recommendation engine, via at least one computer network, a plurality of sent email messages sent by a second computing device associated with a user associated with the unsent email message.

10. The method of claim 9 further comprising, before generating, analyzing (i) each of the accessed plurality of sent email messages and (ii) metadata associated with each of the accessed plurality of sent email messages.

11. The method of claim 10 further comprising, before generating, determining at least one characteristic associated with each of the plurality of sent email message, the at least one characteristic associated with a level of reader engagement.
